(19) United States
(12) Patent Application Publication
(10) Pub. No.: US 2003/0018284 A1
(43) Pub. Date: Jan. 23, 2003

(54) SPINE MASSAGER

(76) Inventor: Sang Hyun LIM, Incheon (KR)

Correspondence Address: Staas &, Halsey, LLP, 700 11th Street, NW, Suite 500, Washington, DC, 20001, US, info@s-n-h.com, (202) 434-1500, (202) 434-1500

(21) Appl. No.: 10/203,522

(22) Filed: Aug. 12, 2002

(30) Foreign Application Priority Data
Feb. 15, 2000 (KR) 2000-7031
Oct. 11, 2000 (KR) 2000-28332
May 26, 2000 (KR) 2000-28619
Oct. 11, 2000 (KR) 2000-59695

(51) Int. Cl. A61H 7/00; A61H 15/00

(52) U.S. Cl. 601/98; 601/99; 601/100; 601/102; 601/103; 601/116

(57) ABSTRACT

### Abstract of Disclosure

Disclosed is a spine massager including a massaging member configured to move vertically along with horizontal reciprocating movements, thereby providing an enhanced massaging therapy effect. The spine massager includes a carrier mounted on a base body to reciprocate horizontally in longitudinal directions of the base body, a massaging member installed on the carrier and provided at an upper surface thereof with a plurality of massaging protrusions, the massaging member being contained with a lamp, a rotating member rotatably mounted on the carrier and provided with a gear portion at a lower end thereof, the rotating member being also provided, at an outer peripheral surface above the gear portion, with three spiral guide grooves uniformly spaced apart from one another by 120° while extending upwardly to an upper end of the rotating member, a normal/reverse rotating motor having a drive gear engaged with the gear portion of the rotating member, and a vertical reciprocating member mounted in the carrier so that it is vertically movable while being prevented from rotating. the vertical reciprocating member carrying the massaging member thereon.

### Background of Invention

Technical Field

The present invention relates to a spine massager including a massaging member configured to move vertically, and more particularly to a spine massager in which a massaging member moves vertically along with horizontal reciprocating movements, thereby providing an enhanced massaging effect in the spine therapy.

Background Art

Spine massagers are known, which are adapted to treat a spine trouble using massage and thermotherapy. Such spine massagers include a massaging member contained with a lamp. As the massaging member moves horizontally, it stimulates blood vessels and spots on the body suitable for acupuncture around the spine. Such spine massagers have the same effect as that obtained by stimulating spots on the body suitable for acupuncture in accordance with a Chinese medicine method such as acupuncture, moxibustion, or massage. Far infrared rays emitted from the lamp have a property of deeply penetrating the skin, so that they provide an acupuncture effect. Electrical heat emitted from the lamp provides an moxibustion effect. Also, the massaging member provides a massaging effect.

Since conventional spine massagers for spine therapy have a configuration in which the massaging member moves only in horizontal directions, the massaging member contacting the spine is kept at a constant level from the body when it is used in a state in which the user lies face up on the spine massager. For this reason, there is a degradation in the effect of massaging blood vessels and spots on the body suitable for acupuncture.

### Summary of Invention

The present invention has been made in view of the above mentioned problem involved in conventional spine massagers, and an object of the invention is to provide a spine massager including a massaging member contained with far infrared rays and electrical heat and adapted to move vertically while reciprocating horizontally, thereby being capable of providing a maximum therapy effect.

In order to accomplish this object, the present invention provides a spine massager comprising a base body, a carrier mounted on the base body to reciprocate horizontally in longitudinal directions of the base body, and a massaging member installed on the carrier and provided at an upper surface thereof with a plurality of massaging protrusions, the massaging member being contained with a lamp, further comprising: a normal/reverse rotating motor; a rotating gear rotatably mounted to the carrier and coupled to the normal/reverse rotating motor, the rotating gear serving to rotate horizontally in accordance with a drive force from the normal/reverse rotating motor; and means for converting a rotating force of the rotating gear into a vertical movement force for vertically moving the massaging member, the means comprising a vertical reciprocating member adapted to reciprocate vertically in accordance with the rotating force of the rotating gear, the vertical reciprocating member carrying the massaging member thereon.

The converting means may further comprise: a cylindrical protrusion member extending downwardly from a lower surface of the massaging member, the protrusion member being fitted in the rotating gear while allowing a rotation of the rotating gear; a plurality of spiral guide grooves formed at an outer peripheral surface of the protrusion member; a fitting hole centrally formed at the rotating gear to receive the protrusion member; guide members formed at an inner peripheral surface of the fitting hole to be engaged with the guide grooves, respectively; a square hole longitudinally formed at a central portion of the protrusion member; and a square protrusion formed at the carrier and fitted in the square hole; whereby the vertical reciprocating member is raised or lowered in accordance with a normal or reverse rotating force of the rotating gear generated by a drive force of the normal/reverse rotating motor under the condition in which it is prevented from rotating with respect to the carrier.

In accordance with another embodiment of the present invention, the guide members are formed at the protrusion member of the vertical reciprocating member whereas the spiral guide grooves are formed at the rotating gear.

Preferably, three guide members are formed in such a fashion that they are spaced apart from one another by 120°, in order to allow the vertical reciprocating member to conduct a smooth reciprocating operation without being inclined. In this case, three guide grooves are formed, which are spaced apart from one another by 120°.

In accordance with another embodiment of the present invention, the converting means comprises: a horizontal guide groove formed at a lower surface of the massaging member; a pair of rods pivotally coupled to each other at intermediate portions thereof to form an X-shaped structure; rollers rotatably mounted to respective upper ends of the rods and slidably received in the horizontal guide groove, one of the rods being hingably mounted to the carrier at a lower end thereof; a nut member attached to a lower end of the other one of the rods; and a normal/reverse rotating motor fixedly mounted to the carrier and provided with a screw shaft threadedly coupled with the nut member. In this case, the angle between the X-shaped rods is varied in accordance with the driving operation of the normal/reverse rotating motor, thereby causing the vertical reciprocating member to be raised or lowered. That is, a vertical reciprocating mechanism using a lift system is provided.

In accordance with another embodiment of the present invention, the massaging member comprises at least one rotatable roller, the massaging protrusions being formed on an outer peripheral surface of the roller.

In accordance with another embodiment of the present invention, the converting means comprises: a normal/reverse motor installed on the carrier; a pair of spiral gears rotatably mounted at opposite lateral ends of the carrier, respectively, to rotate normally or reversely in accordance with a rotation of the normal/reverse rotating motor and formed with a spiral groove having a radius increasing gradually from a center of the spiral gear to an outer periphery of the spiral gear; a vertical reciprocating member seated on the carrier while carrying the massaging member thereon; and movable shafts each fixed to the vertical reciprocating member and received at a free end thereof in the spiral groove of an associated one of the spiral gears.

In accordance with another embodiment of the present invention, the converting means comprises: a normal/reverse rotating motor; a drive gear fitted around a shaft of the normal/reverse rotating motor; a donut-shaped rotating gear mounted to a lower portion of the carrier and provided with inner and outer gear portions, the outer gear portion being engaged with the driving gear; a plurality of rotating members each rotatably mounted to the carrier and provided at a lower end thereof with a gear portion engaged with the inner gear portion of the rotating gear, each of the rotating member being formed with a spiral guide groove at an outer peripheral surface thereof; a vertical reciprocating member inwardly defined with receiving spaces to receive the rotating members, respectively, the vertical reciprocating member carrying the massaging member thereon; and bearings mounted to respective outer surface portions of the vertical reciprocating member corresponding to the receiving spaces, the bearings being partially received in the guide grooves of the rotating members, respectively; whereby the vertical reciprocating member moves vertically with respect to the carrier when the rotating members rotate in accordance with a rotating force of the rotating gear. In this case, two to five or more rotating members may be used, which are inscribed with the rotating gear. A plurality of rotating members may also be arranged at several points on a bottom plate included in the carrier, preferably apices of a triangle, in such a fashion that they are rotatable. The vertical reciprocating member, which is fitted around the rotating members, has an oval shape, The movable member, in which the vertical reciprocating member is fitted, has a vertically-extending fitting hole having the same shape as the contour of the vertical reciprocating member and receiving the vertical reciprocating member. In this case, the vertical reciprocating member reciprocates vertically without using any separate guide member.

In accordance with another embodiment of the present invention, the converting means comprises: a rotating member rotatably mounted on the carrier and provided with a gear portion at a lower end thereof, the rotating member being also provided, at an outer peripheral surface above the gear portion, with three spiral guide grooves uniformly spaced apart from one another by 120° while extending upwardly to an upper end of the rotating member; a normal/reverse rotating motor having a drive gear engaged with the gear portion of the rotating member; and a vertical reciprocating member mounted in the carrier so that it is vertically movable while being prevented from rotating. the vertical reciprocating member carrying the massaging member thereon. When the rotating member rotates in accordance with a driving operation of the normal/reverse rotating motor, the vertical reciprocating member coupled to the spiral guide grooves of the rotating member is vertically moved in accordance with a reaction. As a result, the massaging member mounted on the vertical reciprocating member is vertically moved, thereby massaging the spine portion. In this case, the gear portion of the rotating member may be integral with the rotating member. Alternatively, the gear portion may be provided in the form of a separate circular plate assembled to the rotating member. Where the vertical reciprocating member has bearings, a plate-shaped stopper is attached to an upper end of the rotating member. The stopper serves to prevent the vertical reciprocating member from being separated from the rotating member when it reaches a top dead point thereof. The stopper is provided with portions each partially bent to have the same angle as an associated one of the guide grooves. When the vertical reciprocating member is lowered from its top dead point, the bearings are forcedly introduced into the guide grooves as they are downwardly depressed by the bent portions. According, a smooth lowering operation of the vertical reciprocating member is carried out. In order to prevent the vertical reciprocating member from rotating with respect to the carrier while allowing the vertical reciprocating member to move vertically, guide bearings may be mounted at opposite lateral ends of the vertical reciprocating member. In this case, vertically-extending guide grooves are also formed at an opening of the carrier so that they receive the guide bearings.

### Brief Description of Drawings

Figs. 1 to 5 illustrate a spine massager according to a first embodiment of the present invention, in which

Fig. 1 is a perspective view illustrating the entire configuration of the spine massager,

Fig. 2 is a plan view of the spine massager,

Fig. 3 is an exploded perspective view illustrating a structure for vertically reciprocating a massaging member,

Fig. 4 is an assembled sectional view illustrating the vertical reciprocating structure, and

Fig. 5 is a sectional view illustrating a vertical reciprocating operation of the massaging member;

Fig. 6 is a sectional view illustrating a vertical reciprocating structure according to a second embodiment of the present invention;

Fig. 7 is a perspective view illustrating the entire configuration of a spine massager according to a third embodiment of the present invention, in which a roller type massaging member is used;

Fig. 8 is a cross-sectional view taken along the line A - A of Fig. 7;

Figs. 9 to 13 illustrate a spine massager according to a fourth embodiment of the present invention, in which

Fig. 9 is a perspective view illustrating a movable member,

Fig. 10 is cross-sectional view of the movable member,

Fig. 11 is a sectional view of the movable member, and

Figs. 12 and 13 are sectional views illustrating incompletely and completely-raised states of the vertical reciprocating member, respectively;

Figs. 14 and 15 are a cross-sectional view and a sectional view respective illustrating an embodiment modified from the fourth embodiment of the present invention;

Figs. 16 to 20 illustrate a fifth embodiment of the present invention, in which

Fig. 16 is an exploded perspective view,

Fig. 17 is an assembled perspective view,

Fig. 18 is a cross-sectional view taken along the line A - A of Fig. 17,

Fig. 19 is a cross-sectional view taken along the line B - B of Fig. 17, and

Fig. 20 is a sectional view illustrating a raised state of the massaging member;

Figs. 21 to 25 illustrate a sixth embodiment of the present invention, in which

Fig. 21 is an exploded perspective view,

Fig. 22 is an assembled perspective view,

Fig. 23 is a cross-sectional view taken along the line A - A of Fig. 22,

Fig. 24 is a cross-sectional view taken along the line B - B of Fig. 22, and

Fig. 25 is a sectional view illustrating a raised state of the massaging member; and

Fig. 26 is a perspective view illustrating a vertical reciprocating member according to an embodiment modified from the sixth embodiment of the present invention.

### Detailed Description

Best Mode for Carrying Out the Invention

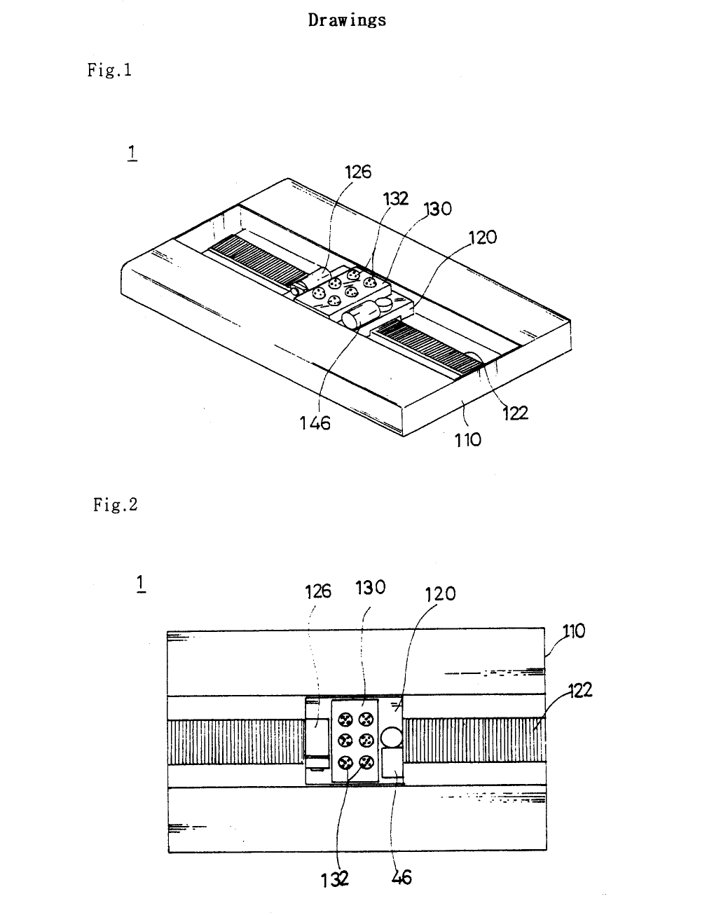

Figs. 1 and 2 are a perspective view and a plan view respectively illustrating the entire configuration of a spine massager according to a first embodiment of the present invention. As shown in Figs. 1 and 2, the spine massager, which is denoted by the reference numeral 1, includes a base body 110, and a carrier 120 mounted in a recess formed at the central portion of the base body 110 in such a fashion that it can reciprocate longitudinally. A massaging member 130 having a plurality of massaging protrusions 132 is mounted on the carrier 120. A lamp (not shown) for generating far infrared rays and electrical heat is contained in the massaging member 130.

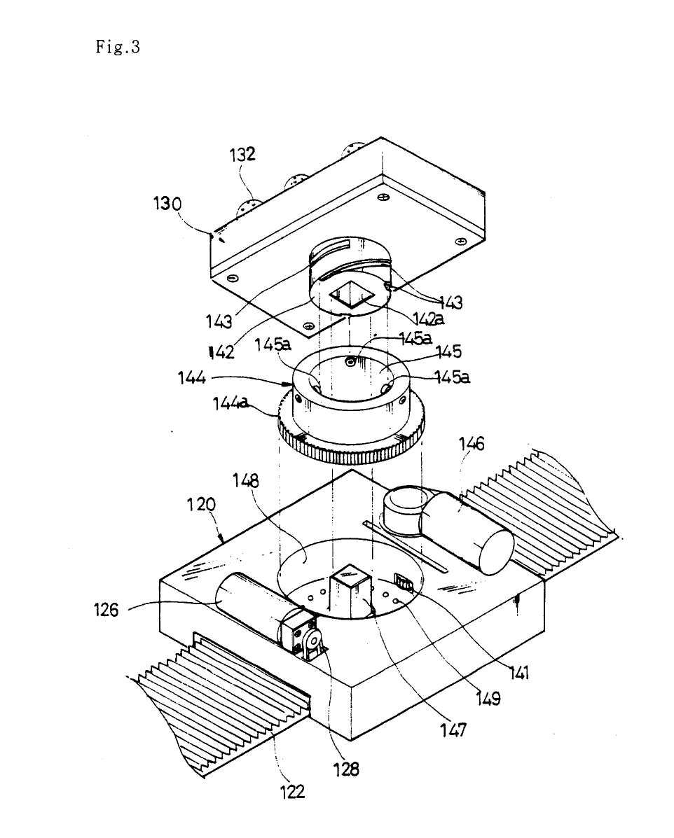

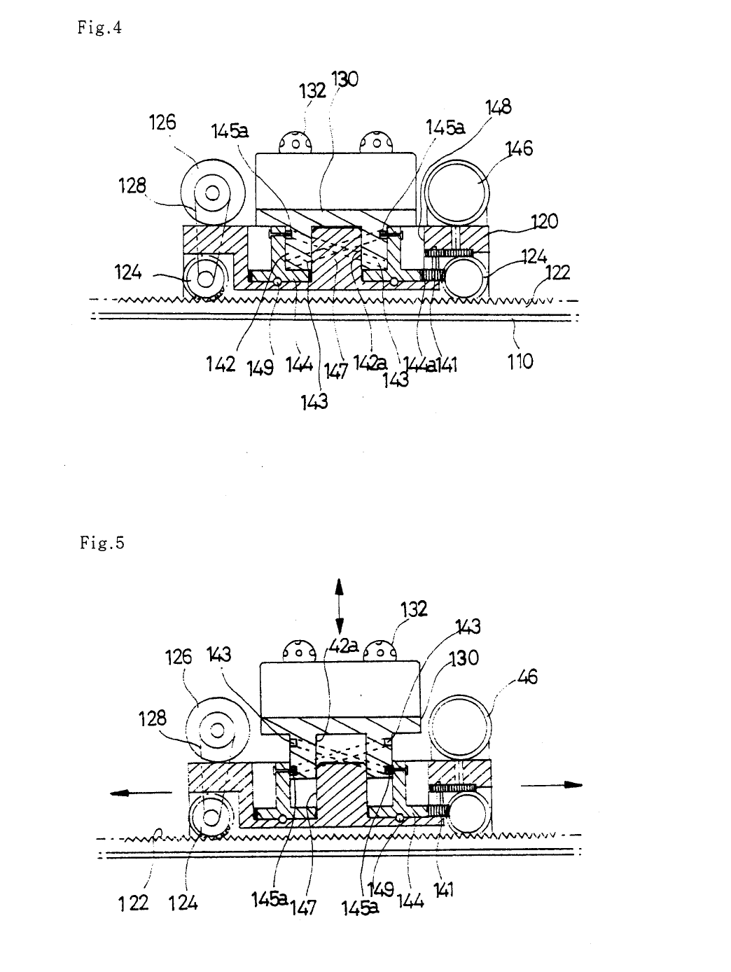

A driving mechanism for the carrier 120 is illustrated in an exploded perspective view of Fig. 3 and a cross-sectional view of Fig. 4. As shown in Figs. 3 and 4, the driving mechanism includes a rack gear 122 provided at the bottom surface of the recess of the base body 110, a pinion gear 124 mounted to the lower portion of the carrier 120, and a drive motor 126 fixedly mounted to the carrier 120 and adapted to transmit a drive force to the pinion gear 124. The rotating force of the drive motor 126 is transmitted to the pinion gear 124 by a power transmission means 128, so that the carrier 120 is horizontally movable in a desired direction along the rack gear 122 formed at the base body 110. Thus, the carrier 120 reciprocates in accordance with normal and reverse rotations of the drive motor 126.

In order to vertically move the massaging member 130 mounted on the carrier 120, another driving mechanism is also provided. This driving mechanism adapted for vertical movements of the massaging member 130 includes a cylindrical protrusion member 142 extending downwardly from the lower surface of the massaging member 130, a rotating gear 144 fitted around the protrusion member 142 and received in the interior of the carrier 120, and a normal/reverse rotating motor 146 for rotating the rotating gear 144. By this configuration, the massaging member driving mechanism serves to change normal and reverse rotations of the rotating gear 144 into upward and downward movements of the massaging member 130. This mechanism utilizes the principle of a screw.

In order to vertically move the massaging member 130, a plurality of spiral guide grooves 143 are formed at the outer peripheral surface of the protrusion member 142 protruded from the lower surface of the massaging member 130. A fitting hole 145 is centrally formed at the rotating gear 144 to receive the protrusion member 142. Guide members 145a are formed at the inner peripheral surface of the fitting hole 145 so that they are engaged with the guide grooves 143, respectively. A square hole 142a is longitudinally formed at the central portion of the protrusion member 142. A square protrusion 147 is formed at the carrier 120 so that it is fitted in the square hole 142a. By virtue of the structure including the square hole 142a and square protrusion 147, the massaging member 130 cannot rotate. When the rotating gear 144 rotates, the guide members 145a formed at the fitting hole 145 of the rotating gear 144 moves spirally along the guide grooves 143 formed at the protrusion member 142 of the massaging member 130. At this time, the massaging member 130 does not rotate because the square protrusion 147 of the carrier 120 is fitted in the square hole 142a of the massaging member 130. In accordance with the rotation of the rotating gear 144, therefore, the massaging member 130 moves upwardly or downwardly, based on the rotating direction of the rotating gear 144. The vertical movement distance of the massaging member 130 corresponds to the tangent value of the angle of each spiral guide groove 143 from a horizontal plane with respect to the spiral distance moved by the guide member 145a of the rotating gear 144.

In Figs. 1 and 2, the reference numeral 148 denotes a circular gear receiving recess formed at the carrier 120 to allow the rotating gear 144 to be seated therein, and the reference numeral 141 denotes a drive gear connected to the normal/reverse rotating motor 146. The drive gear 141 is engaged with a gear portion 144a formed at the outer peripheral surface of the rotating gear 144 so as to rotate the rotating gear 144.

The operation of the spine massager having the above mentioned configuration according to the first embodiment of the present invention will be described in conjunction with Fig. 5.

The carrier 120 is horizontally moved by the drive motor 126. That is, the rotating force of the drive motor 126 is transmitted to the pinion gear 124 by the power transmission means 128 such as a chain or belt, thereby causing the pinion gear 124 to rotate. As the pinion gear 124 rotates, it moves horizontally along the rack gear 122 fixedly mounted to the base body 110.

The moving speed of the carrier 120 may be optionally adjusted using a separate controller. Contact type or non-contact type limit switches (not shown) are installed at opposite ends of the rack gear 122. Each limit switch serves to change the rotating direction of the drive motor 126 when the carrier 120 reaches an end of the rack gear 122 where the limit switch is installed, thereby changing the movement direction of the carrier 120 into an opposite direction. Thus, the carrier 120 can reciprocate repeatedly along the rack gear 122.

When the carrier 120 moves horizontally, the massaging member 130 installed on the carrier 120 moves upwardly and downwardly in a repeated fashion. That is, the rotation of the rotating gear 144 conducted by the normal/reverse rotating motor 146 is changed into a linear movement serving to raise or lower the massaging member 130. When the drive gear 141 coupled to the normal/reverse rotating motor 146 rotates in a counter-clockwise direction in the state of Fig. 4 in which the massaging member 130 is positioned at its lowest position, the rotating gear 144 is moved in a clockwise direction. As a result, each guide member 145a, which has a bearing structure, moves along the associated spiral guide groove 143 formed at the outer peripheral surface of the protrusion member 142 extending downwardly from the massaging member 130. At this time, the massaging member 130 is raised in proportion to the rotating angle of the rotating gear 144 in accordance with a screw principle under the condition in which it cannot rotate because its square hole 142a is fitted around the square protrusion 147 fixed to the central portion of the gear receiving recess 148 formed at the carrier 120. In accordance with the upward movement of the massaging member 130, the massaging protrusions 132 formed at the upper surface of the massaging member 130 strongly depress the spine portion of the human body.

Preferably, three guide members 145a are provided which are uniformly spaced apart from one another by 120°. Also, three spiral guide grooves 143, which receive respective guide members 145a, are formed on the outer peripheral surface of the protrusion member 142 extending downwardly from the massaging member 130 in such a fashion that they correspond to respective movement paths of the guide members 145a. Accordingly, the massaging member 142 is maintained in a supported state at three points when it moves upwardly or downwardly. Therefore, the massaging member 130 conducts smooth vertical movements without being inclined in any direction.

The spiral guide grooves 143 formed at the protrusion member 142 extending downwardly from the massaging member 130 are uniformly spaced apart from one another by 120°. Each spiral guide groove 143 also forms an angle of 120° to 240°, preferably 180°, about the center of the protrusion member 142 between the upper and lower ends thereof. Thus, the massaging member 130 is completely raised from the lower end to the upper end of the spiral guide groove 143 or completely lowered from the upper end to the lower end of the spiral guide groove 143 when the rotating gear 144 rotates a half turn.

Respective numbers of the guide members 145a and guide grooves 143 may be ranged from 2 to 4.

Although each guide member 145 has been illustrated as having a bearing structure, it may have a simple circular protrusion structure. In this case, a lubricant such as grease may be coated over the guide member 145 in order to obtain a smooth slide of the guide member 145 while reducing a friction generated at the portion of the guide member 145 contacting the associated guide groove 143.

In accordance with a modified embodiment of the present invention, the positions of the guide members and guide grooves may be arranged at reverse positions. That is, the guide grooves 143 may be formed at the inner peripheral surface of the fitting hole 145 of the rotating gear 144 whereas the guide members 145a may be formed at the outer peripheral surface of the protrusion member 142 of the massaging member 130.

Thus, the massaging member 130 effectively massages the spine while repeating upward and downward movements as the rotating gear 144 changes its rotating direction in accordance with the rotating direction of the normal/reverse rotating motor 146.

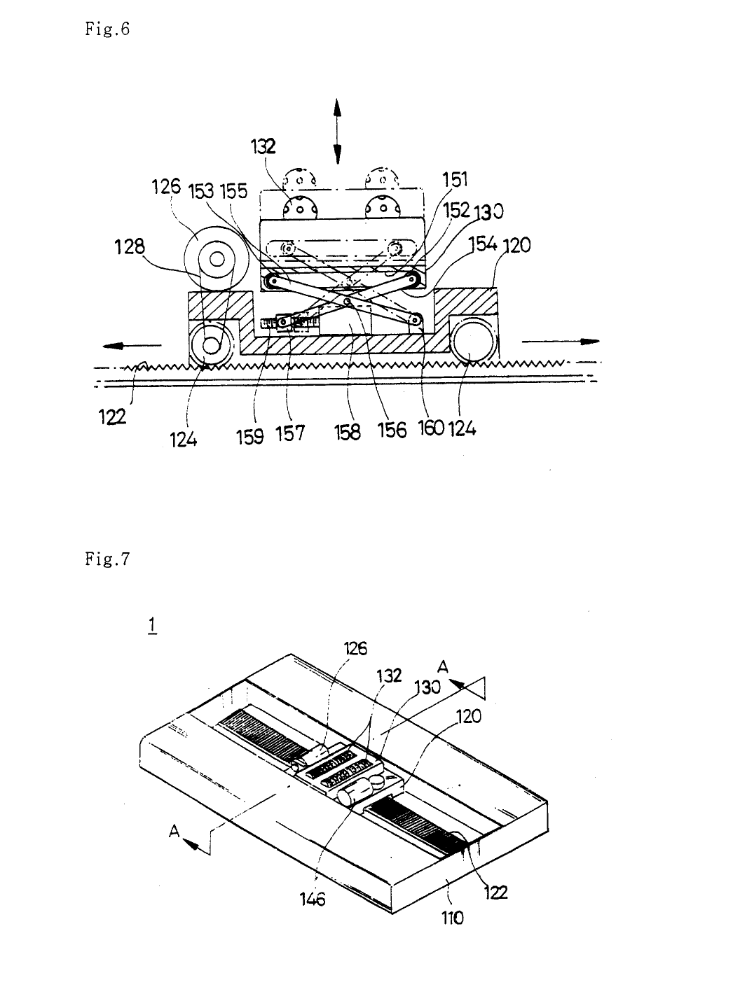

Fig. 6 illustrates a second embodiment of the present invention. In accordance with this embodiment, the mechanism for horizontally moving the carrier 120 on the rack gear 122 is identical to that of the first embodiment. However, the mechanism for vertically reciprocating the massaging member 130 uses a lift system in accordance with the second embodiment. That is, rods 154 and 155 are pivotally coupled to each other by means of a pivot pin 156 to form an X-shaped structure. Rollers 152 and 153 are rotatably mounted to respective upper ends of the rods 154 and 155. These rollers 152 and 153 are slidably received in a horizontal guide groove 151 formed at the lower surface of the massaging member 130. The lower end of the rod 155 is hingably mounted to the carrier 120. The lower end of the rod 154 is attached with a nut member 157. This nut member 157 is coupled to a screw shaft 159 provided at a normal/reverse rotating motor 158 fixedly installed on the carrier 120 so that it is horizontally moved along the screw shaft 159 in accordance with a rotation of the screw shaft 159. That is, when the normal/reverse rotating motor 158 drives, the angle between the rods 154 and 155 is varied, thereby causing the massaging member 140 to move upwardly or downwardly while maintaining its horizontal status.

In Fig. 6, the reference numeral 160 denotes a fixing member for hingably mounting the lower end of the rod 155.

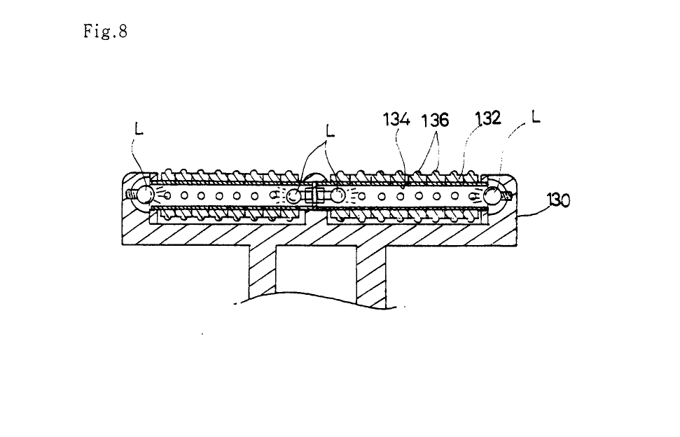

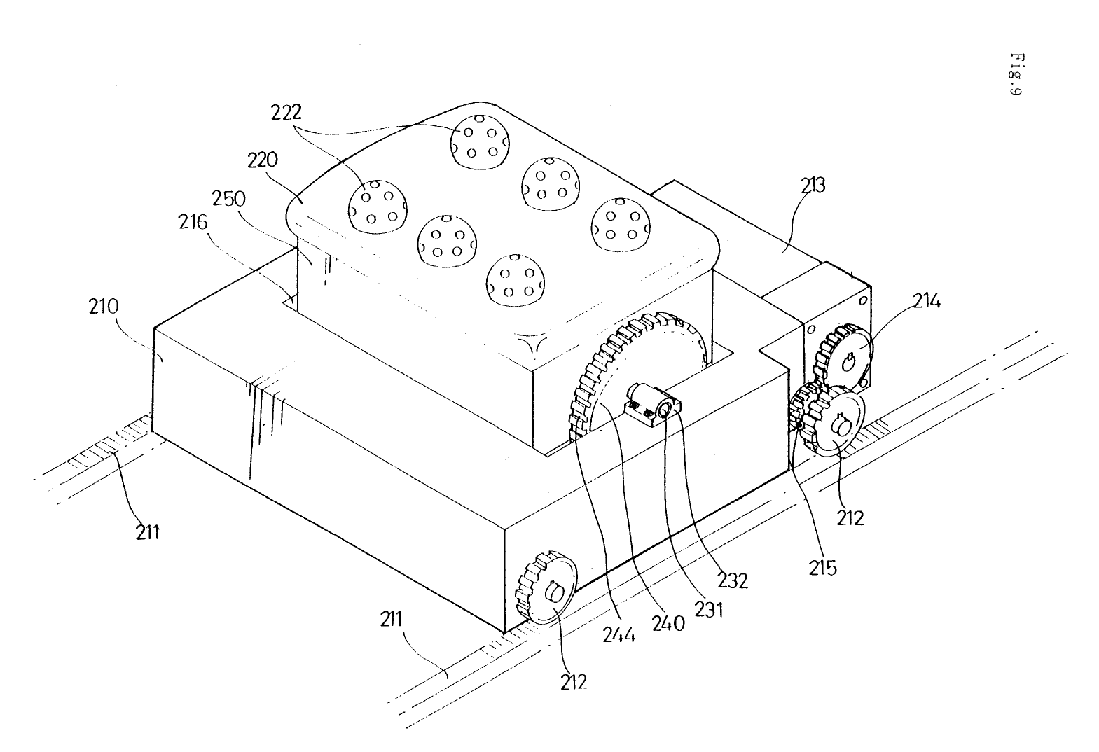

Figs. 7 and 8 illustrate a third embodiment of the present invention, respectively. In accordance with this embodiment, the mechanism for vertically reciprocating the massaging member 130 may be identical to that of the first or second embodiment. In accordance with the third embodiment, however, the configurations of massaging protrusions and lamp are different from those of the first and second embodiments. In accordance with this embodiment, a plurality massaging rollers 132 are rotatably fitted around a single bobbin shaft 134. Radial massaging protrusions 136 are formed on the outer surface of each massaging roller 132 so as to obtain an effective massaging effect. Preferably, each massaging roller 132 is made of a synthetic resin containing a bioceramic substance radiating far infrared rays.

Lamps L adapted to emit far infrared rays and electrical heat are arranged at an intermediate portion and opposite ends of the bobbin 134, respectively. In accordance with this embodiment, the spine massager provides an effect of applying far infrared rays and electrical heat to the human body, along with a massaging effect.

In the embodiment of Figs. 7 and 8, the massaging rollers 132 are illustrated as being arranged in two rows in such a fashion that those of one row are aligned with those of the other row. However, it is also possible to arrange the massaging rollers 132 in two rows in such a fashion that those of one row alternate with those of the other row. In this case, an enhanced massaging effect is obtained. Alternatively, the massaging rollers 132 may be arranged in a separate fashion so that they massage particular portions of the human body, respectively.

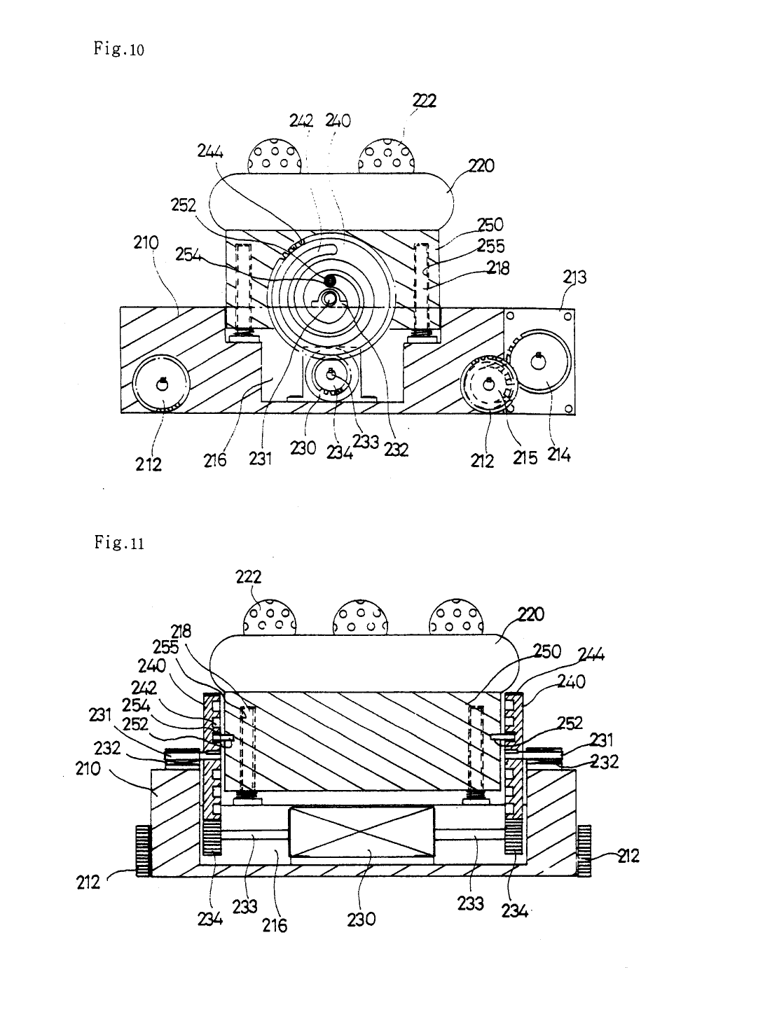

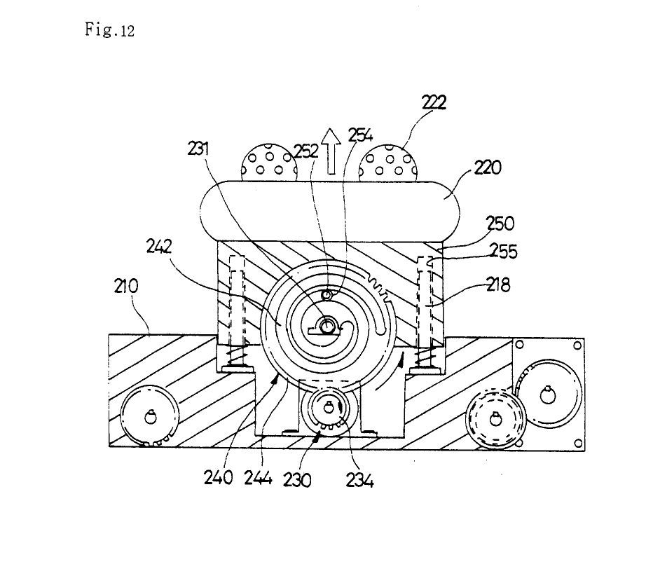

Fig. 9 is a perspective view schematically illustrating the entire configuration of a spine massager including a carrier and a vertical reciprocating member in accordance with a fourth embodiment of the present invention. Figs. 10 and 11 are a cross-sectional view and a sectional view illustrating a massaging member reciprocating mechanism according to the fourth embodiment. In accordance with this embodiment, the spine massager includes a carrier 210 installed in the interior of the spine massager to move horizontally, and a vertical reciprocating member 250 seated on the carrier 210 and contained with lamps (not shown) adapted to generated far infrared rays and electrical heat. The vertical reciprocating member 250 is provided with a massaging member 220 having a plurality of massaging protrusions 222.

The spine massager also includes a driving mechanism for moving the carrier 210. This carrier driving mechanism includes rack gears 211 provided at the inner bottom surface of the spine massager, pinion gears 212 each mounted to the lower portion of the carrier 210 and engaged with an associated one of the rack gears 212, and a drive motor 126 fixedly mounted to the carrier 210 and adapted to transmit a drive force to the pinion gears 212. A power transmission gear 215 is fixedly mounted to a shaft to which one of the pinion gears 212 is mounted. The power transmission gear 215 is engaged with a gear 214 fixedly mounted to a shaft of the drive motor 213. Accordingly, when the drive motor 213 drives, the pinion gear 212 is rotated, thereby causing the carrier 210 to move horizontally along the rack gears 211 on the spine massager. Thus, the carrier 210 reciprocates in accordance with normal and reverse rotations of the drive motor 126.

In order to vertically move the vertical reciprocating member 250 mounted on the carrier 210, another driving mechanism is also provided. This driving mechanism includes a normal/reverse motor 230 installed in a recess 216 defined in the carrier 210, a spiral gear 240 mounted to the carrier 210 via a fixed shaft 231 to rotate normally or reversely in accordance with a rotation of the normal/reverse rotating motor 230 and formed with a spiral groove 242 having a radius increasing gradually from the center of the spiral gear 240 to the outer periphery of the spiral gear 240, and a movable shaft 252 fixed to the vertical reciprocating member 250 and received at its end in the spiral groove 242 of the spiral gear 240. By this configuration, when the spiral gear 240 fixedly mounted to the carrier 210 is rotated in one direction in accordance with a drive force from the normal/reverse rotating motor 230, the movable shaft 252 of the vertical reciprocating member 250 received in the spiral groove 242 of the spiral gear 240 is raised while being guided by the spiral groove 242. On the other hand, when the spiral gear 240 rotates in an opposite direction, the moveable shaft 252 of the vertical reciprocating member 250 is lowered while being guided by the spiral groove 242. Thus, the vertical reciprocating member 250 fixed to the movable shaft 252 reciprocates vertically. Accordingly, an effective massaging force is generated as the massaging member 220 arranged on the vertical reciprocating member 250 reciprocates vertically.

In the illustrated case, two spiral gears 240 are arranged at opposite lateral ends of the carrier 210 in such a fashion that the vertical reciprocating member 250 is arranged therebetween. A pair of movable shafts 252 are protruded from opposite lateral ends of the vertical reciprocating member 250 in such a fashion that they are received in the spiral grooves 242 of the spiral gears 240, respectively. In order to allow a smooth sliding movement of each movable shaft 252 along the associated spiral groove 242, a bearing 254 is fitted around the movable shaft 252.

This embodiment uses a power transmission mechanism using gears to transmit the drive force from the normal/reverse rotating motor 230 mounted in the recess 216 of the carrier 210 to the spiral gear 240 via a gear 234 fixedly mounted to the shaft 233 of the motor 230 and a gear 244 formed at the outer periphery of the spiral gear 240. Of course, the present invention is not limited to this mechanism, and various mechanisms may be used to transmit the drive force of the normal/reverse rotating motor 230 to the spiral gear 240. In accordance with this embodiment, a plurality of guide holes 255 are formed at respective corners of the vertical reciprocating member 250 in such a fashion that they extend vertically from the bottom of the vertical reciprocating member 250. Vertical guide bars 218 are fixedly mounted to the upper surface of the carrier 210 at positions corresponding to those of the guide holes 255 in such a fashion that they are received in the guide holes 255, respectively. By this configuration, there is no phenomenon that the vertical reciprocating member 250 is inclined from a horizontal plane during its vertical movement. The positions of the guide bars 218 and guide holes 255 may be arranged at reverse positions. That is, the guide holes 255 may be formed at the carrier 210 whereas the guide bars 218 may be formed at the vertical reciprocating member 250. Also, these guide bars 218 and guide holes 255 may be dispensed with in order to simplify the vertical reciprocating mechanism. In this case, the front and rear surfaces of the vertical reciprocating member 250 and the inner front and rear surfaces of the carrier 210 may have a dovetail structure enabling the vertical reciprocating member 250 and carrier 210 to be coupled together in a dovetailed fashion.

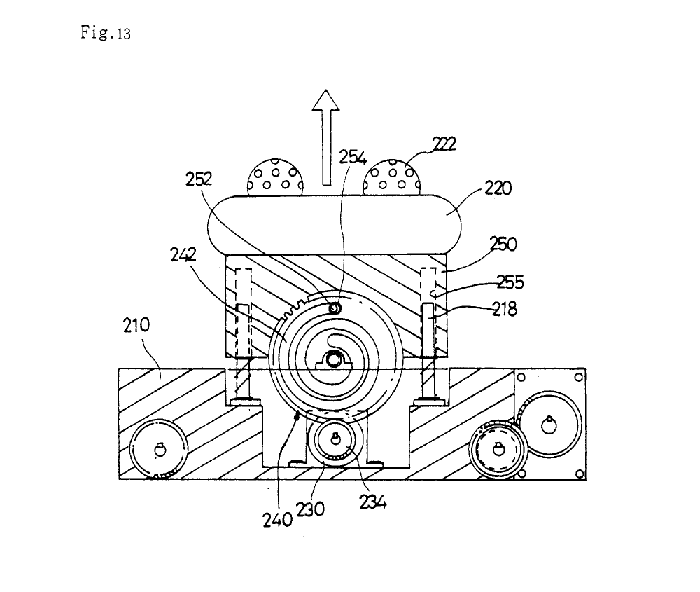

In accordance with this embodiment, the vertical reciprocating member 250 installed on the carrier 210 can move vertically at a desired position under the condition in which the carrier 210 has moved horizontally to that position. This operation is achieved as the rotation of the spiral gear 240 conducted by the normal/reverse rotating motor 230 is changed into a vertical movement for raising or lowering the carrier 250. When the gear 234 coupled to the normal/reverse rotating motor 230 rotates in a clockwise direction in the state of Fig. 10 in which the vertical reciprocating member 250 is positioned at its lowest position, each spiral gear 240 is rotated in a counter-clockwise direction. As a result, each movable shaft 252, which is mounted to each lateral end of the vertical reciprocating member 250 and received in the spiral groove 242 of the associated spiral gear 240, is vertically moved away from the center of the associated spiral gear 240 while being guided by the spiral groove 242. That is, the movable shaft 252 is vertically raised, as shown in Figs. 12 and 13. Accordingly, the vertical reciprocating member 250 is vertically raised from the carrier 210. By virtue of the upward movement of the vertical reciprocating member 250, the massaging protrusions 222 of the massaging member 220 can strongly depress a desired portion of the human body. Therefore, an enhanced massaging effect is obtained.

The downward movement of the vertical reciprocating member 250 is carried out in accordance with the procedure reverse to that of the above mentioned upward movement. A limit switch is installed at an appropriate position of the vertical reciprocating member 250. The limit switch serves to change the movement direction of the vertical reciprocating member 250 when the vertical reciprocating member 250 reaches its top dead point as it moves upwardly, thereby causing the vertical reciprocating member 250 to move downwardly.

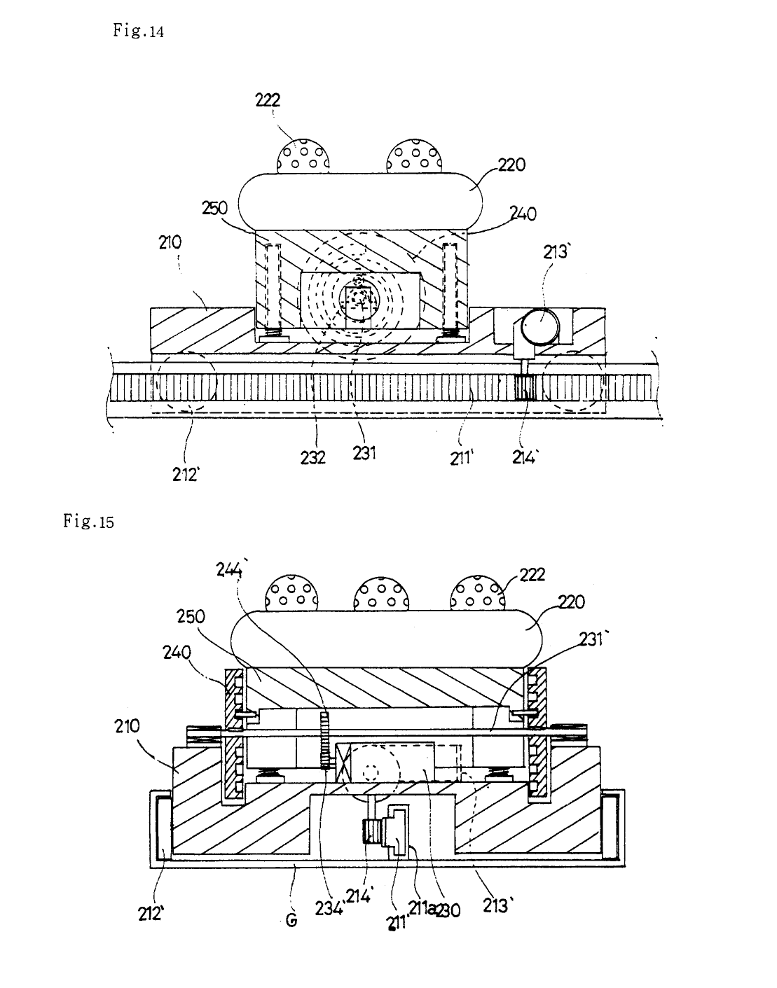

Figs. 14 and 15 illustrate an embodiment modified from the fourth embodiment of the present invention. The driving mechanism for horizontally reciprocating the carrier 210 in this embodiment is different from that of the fourth embodiment. Also, this embodiment is different from that of the fourth embodiment in terms of the mechanism for vertically reciprocating the vertical reciprocating member 250.

In accordance with this embodiment, the mechanism for driving the carrier 210 includes a rack gear 211 fixedly mounted to a fixed bracket 211a fixedly mounted to the intermediate portion of a guide member G in such a fashion that it extends longitudinally. A pinion gear 214 is axially coupled to the shaft of a drive motor 213 mounted to the carrier 210. Rollers 212 are attached to front and rear ends of the carrier 210, respectively. The guide member G is interposed between the rollers 212 so that it can be rolled in forward and rearward directions. By this configuration, the carrier 210 can move forwardly and rearwardly in accordance with normal and reverse rotations of the normal/reverse rotating motor 213.

In accordance with this embodiment, the mechanism for vertically reciprocating the vertical reciprocating member 250 is identical to that of the first embodiment. However, this embodiment uses a modified power transmission mechanism. That is, a gear 234 is mounted to the shaft of the normal/reverse rotating motor 230. The gear 234 is engaged with a gear 244 axially coupled to a fixed shaft 231 to which a spiral gear 240 is mounted. Accordingly, when the normal/reverse rotating motor 230 drives, the spiral gear 240 is rotated in a clockwise or counter-clockwise direction. The vertical reciprocation of the vertical reciprocating member is identical to that of the fourth embodiment.

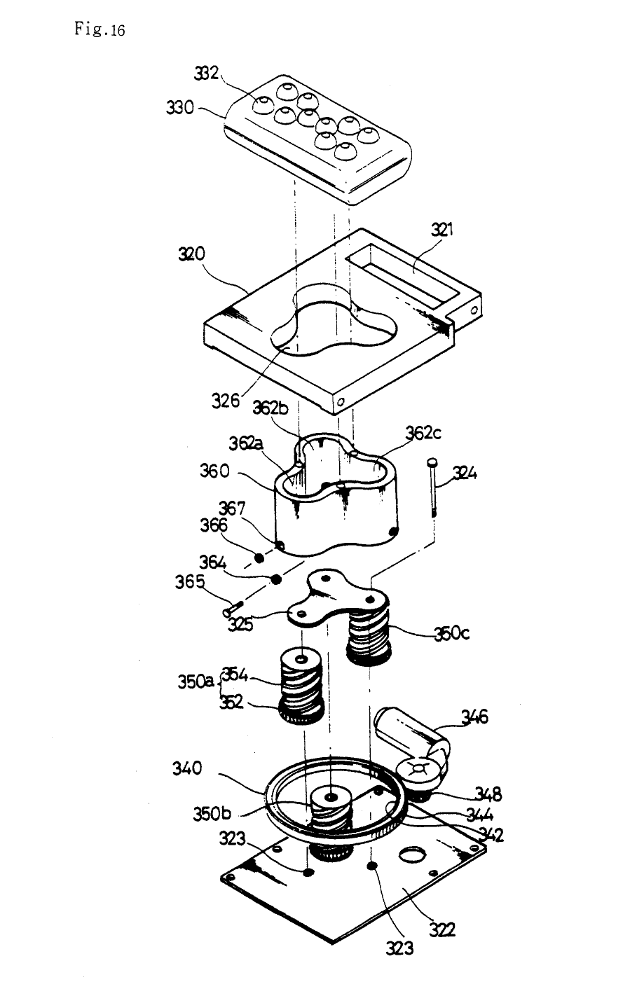

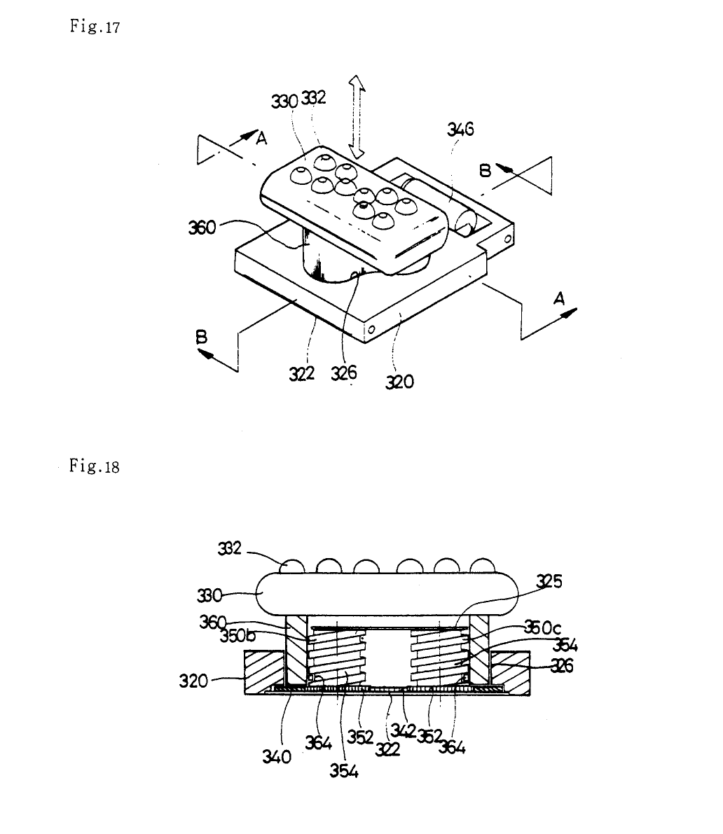

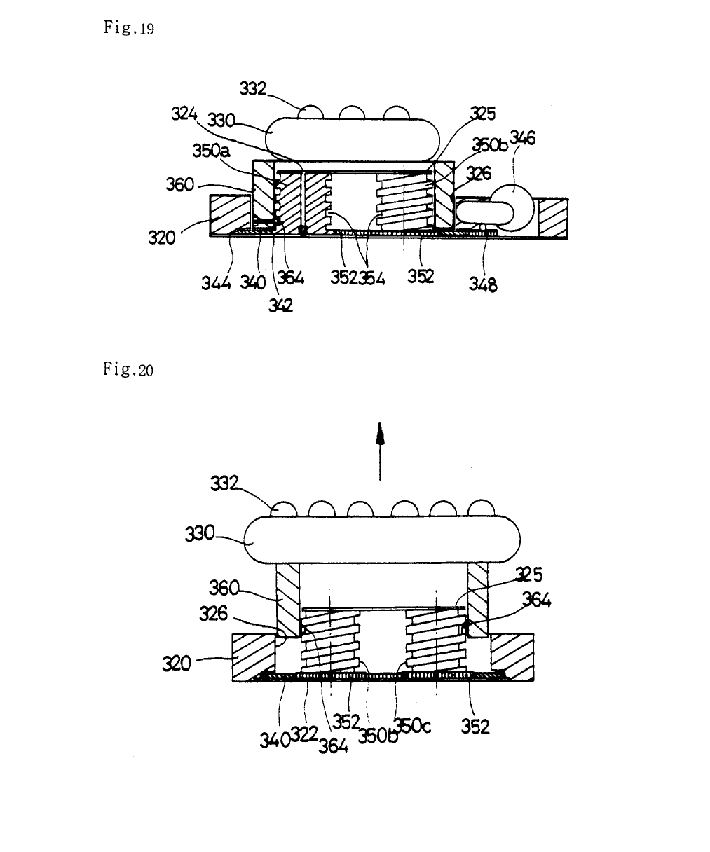

Figs. 16 and 17 are an exploded perspective view and an assembled perspective view respectively illustrating the entire configuration of a spine massager according to a fifth embodiment of the present invention. Figs. 18 and 19 are cross-sectional views respectively taken along the lines A - A and B - B of Fig. 17.

As shown in Figs. 16 to 19, the spine massager according to the fifth embodiment includes a carrier 320 installed on a body (not shown) to reciprocate longitudinally on the body, and a massaging member 330 installed on the carrier 320 and provided with a massaging member 330 having massaging protrusions 332. The spine massager also includes a donut-shaped rotating gear 340 mounted to the lower portion of the carrier 320 and provided with inner and outer gear portions 342 and 344. The outer gear portion 344 of the donut-shaped rotating gear 340 is engaged with a driving gear 348 fitted around the shaft of a normal/reverse rotating motor 346. The spine massager further includes three rotating members 350a, 350b, and 350c each having, at the lower end thereof, a gear portion 352 engaged with the inner gear portion 342 of the rotating gear 340. Each rotating member is also formed with a spiral guide groove 354 on the outer peripheral surface thereof. A vertical reciprocating member 360 is also provided. The vertical reciprocating member 360 is inwardly defined with receiving spaces 362a, 362b, and 362c to receive the rotating members 350a, 350b, and 350c, respectively. Bearings 364 are mounted to respective outer surface portions of the vertical reciprocating member 360 corresponding to the receiving spaces 362a, 362b, and 362c. The bearings 364 are partially received in the guide grooves 354 of the rotating members 350a, 350b, and 350c, respectively. By this configuration, the vertical reciprocating member 360 moves upwardly or downwardly with respect to the carrier 320 when the rotating members 350a, 350b, and 350c rotate in accordance with a rotating force of the rotating gear 340.

As shown in Fig. 18, the rotating gear 340 is arranged between the lower surface of the carrier 320 and the upper surface of a bottom plate 322 in such a fashion that its outer gear portion 344 is engaged with the driving gear 348 fitted around the shaft of the normal/reverse rotating motor 346 whereas the inner gear portion 342 of the rotating gear 340 is engaged with the gear portions 352 of the rotating members 350a, 350b, and 350c in an inscribed fashion. Accordingly, when the normal/reverse rotating motor 346 rotates in one direction, the rotating gear 340 is rotated in the same direction, so that the rotating members 350a, 350b, and 350c engaged with the rotating gear 340 are rotated in the same direction.

In Fig. 16, the reference numeral 321 denotes a motor installation portion formed at the carrier 320. The reference numeral 323 denotes fixing holes formed at the bottom plate 322. The rotating members 350a, 350b, and 350c are rotatably mounted to the fixing holes 323 by means of mounting pins 324, respectively. The reference numeral 325 denotes a fixing plate mounted over the rotating members 350a, 350b, and 350c. The fixing plate 325 has holes for allowing the mounting pins 324 to pass therethrough. The mounting pins 324 extend through the rotating members 350a, 350b, and 350c so that their lower ends is threadedly coupled to the fixing holes 323, thereby allowing the rotating members 350a, 350b, and 350c to be rotatably mounted to the bottom plate 322. The reference numeral 326 denotes a hole for fitting the vertical reciprocating member 360 therein. The hole 326 has the same shape as the contour of the vertical reciprocating member 360.

Also, the reference numerals 365, 366, and 367 are a bolt, a nut, and a bolt hole for mounting each bearing 364 to the vertical reciprocating member 360.

The rotating members 350a, 350b, and 350c have the same shape. As mentioned above, each rotating member is provided at the lower end thereof with the gear portion 352 engaged with the inner gear portion 342 of the rotating gear 340. Above the gear portion 352, each rotating member is also formed at the outer peripheral surface thereof with the guide groove 354 having the form of a single spiral and extending from the lower portion to the upper end of the rotating member.

Now, the procedure for vertically moving the massaging member in accordance with this embodiment will be described. First, when the rotating members 350a, 350b, and 350c rotate in a clockwise direction when viewed in Fig. 18, the bearings 364, which are received in the spiral guide grooves 354 of the rotating members 350a, 350b, and 350c and mounted to the lower portion of vertical reciprocating member 360 at positions respectively corresponding to the receiving spaces 362a, 362b, and 362c, is raised along the spiral guide grooves 354. As a result, the vertical reciprocating member 360 is vertically raised. Thus, the state of Fig. 20 is obtained.

At this time, the vertical reciprocating member 360 is movable only in a vertical direction without being allowed to rotate because it is fitted in the fitting hole 326 formed at the carrier 320 to have an oval shape.

Therefore, the massaging member 330 fixedly mounted on the vertical reciprocating member 360 is raised, so that the massaging protrusions 332 on the massaging member 330 can strongly depress a desired portion of the spine. Since the spiral guide grooves 354 respectively formed at the rotating members 350a, 350b, and 350c have the form of a single spiral in accordance with this embodiment, they have a gentle inclination. Accordingly, there is an advantage in that the vertical reciprocating member 360 operates smoothly without applying an overload to the normal/reverse rotating motor 346.

When the normal/reverse rotating motor 346 rotates in a reverse direction, the rotating members 350a, 350b, and 350c are rotated in the reverse direction. Accordingly, the bearings 364 received in the guide grooves 354 of the rotating members 350a, 350b, and 350c are lowered along the spiral guide grooves 354. Thus, the vertical reciprocating member 360 is vertically lowered.

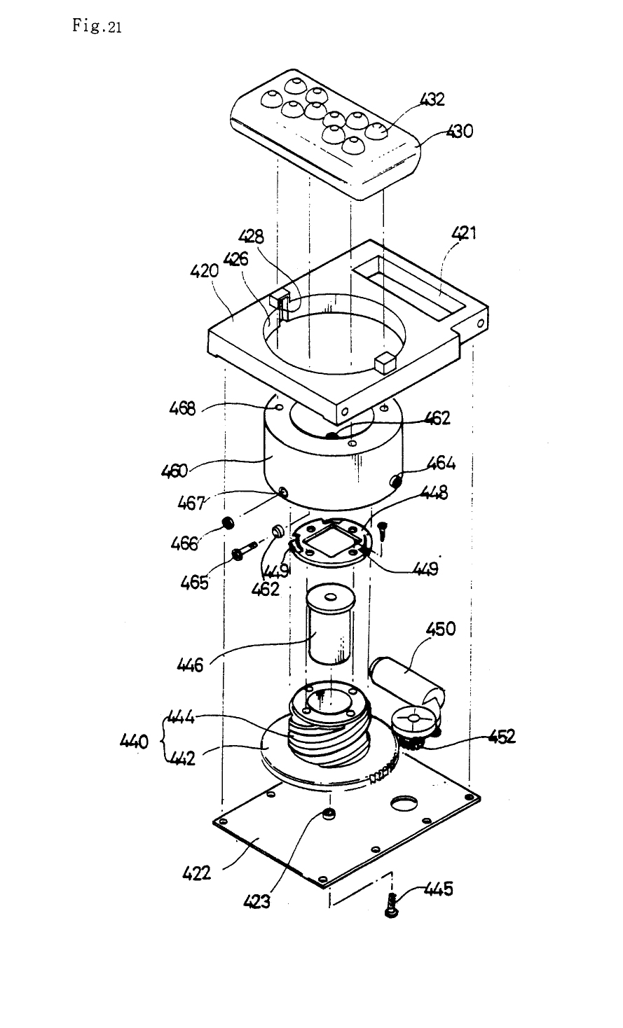

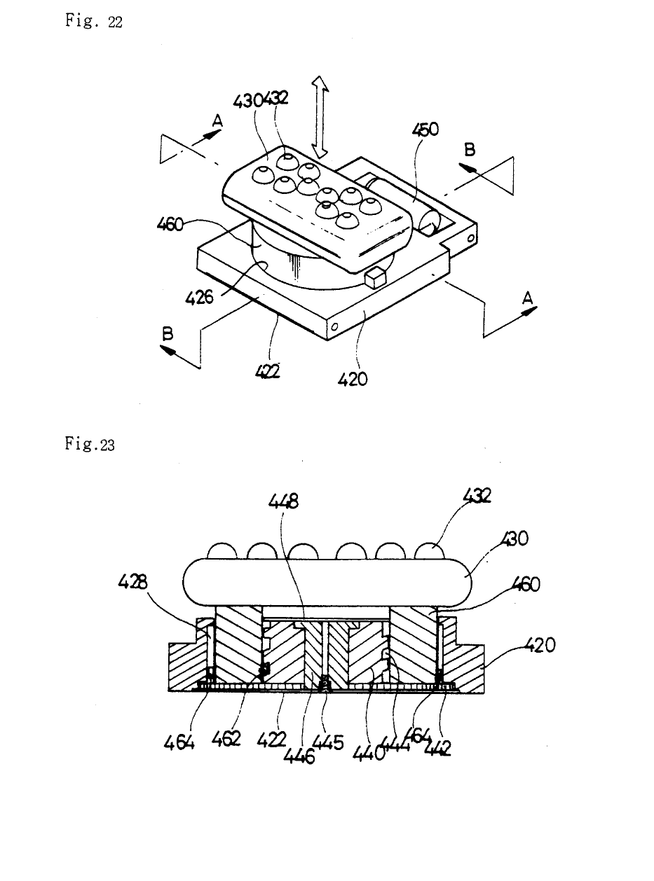

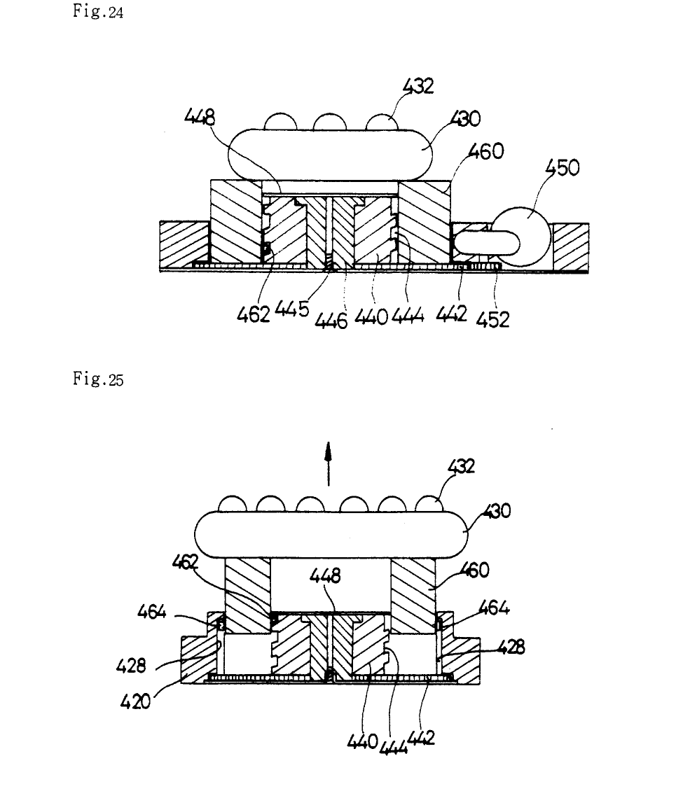

Figs. 21 and 22 are an exploded perspective view and an assembled perspective view respectively illustrating the entire configuration of a spine massager according to a sixth embodiment of the present invention. Figs. 23 and 24 are cross-sectional views respectively taken along the lines A - A and B - B of Fig. 22.

As shown in Figs. 21 to 24, the spine massager according to the sixth embodiment includes a carrier 420 installed on a body (not shown) to reciprocate longitudinally on the body, and a massaging member 430 installed on the carrier 420 and provided with a massaging member 430 having massaging protrusions 432. The spine massager also includes a rotating member 440 rotatably mounted on a bottom plate 422 included in the carrier 420. The rotating member 440 is provided with a gear portion 442 at its lower end. Above the gear portion 442, the rotating member 440 is also provided at the outer peripheral surface thereof with three spiral guide grooves 444 uniformly spaced apart from one another by 120° while extending upwardly to the upper end of the rotating member 440. The spine massager further includes a normal/reverse rotating motor 450 having a drive gear 452 engaged with the gear portion 442 of the rotating member 440, and a vertical reciprocating member 360 mounted in the carrier 420 in such a fashion that it is vertically movable while being prevented from rotating. Three bearings 462 are mounted to the inner surface of the vertical reciprocating member 360 at the lower portion of the vertical reciprocating member 360 in such a fashion that they are partially received in the guide grooves 444 of the rotating member 440, respectively. The massaging member 430 is fixedly mounted on the upper surface of the vertical reciprocating member 360. By this configuration, the vertical reciprocating member 460 coupled to the spiral guide grooves 444 of the rotating member 440 moves upwardly or downwardly when the rotating member 440 rotates in accordance with a driving operation of the normal/reverse rotating motor 450. Thus, the massaging member 430 installed on the vertical reciprocating member 460 can depress the spine portion of the human body as it moves upwardly.

The rotating member 440 is rotatably fitted around a fixing boss 446 fixedly mounted to the bottom plate 442 by means of set screws 445 coupled to fixing holes 423 provided at the bottom plate 422 so that it is rotatably mounted to the bottom plate 442. A plate-shaped stopper 448 is attached to the upper end of the rotating member 440 in order to prevent the vertical reciprocating member 460 from being separated from the rotating member 440 when it reaches its top dead point. The stopper 448 is provided with portions 449 each partially bent to have the same angle as an associated one of the guide grooves 444. The bent portions 449 serve to guide the vertical reciprocating member 460 when that vertical reciprocating member 460 is lowered from its top dead point to its bottom dead point, in order to allow the vertical reciprocating member 460 to be normally lowered along the spiral guide grooves 444 of the rotating member 440 without causing the rotating member 440 to run idle.

In Fig. 21, the reference numeral 421 denotes a motor installation portion formed at the carrier 420. Also, the reference numerals 465, 466, and 467 are a bolt, a nut, and a bolt hole for mounting each bearing 462 to the vertical reciprocating member 460. The reference numeral 468 denotes fixing holes for fixing the massaging member 430 to the upper end of the vertical reciprocating member 430.

In order to prevent the vertical reciprocating member 460 from rotating with respect to the carrier 420 while allowing the vertical reciprocating member 460 to move vertically, guide bearings 464 are mounted at opposite lateral ends of the vertical reciprocating member 460. Vertically-extending guide grooves 428 are also formed at an opening 426 of the carrier 420 so that they receive the guide bearings 464.

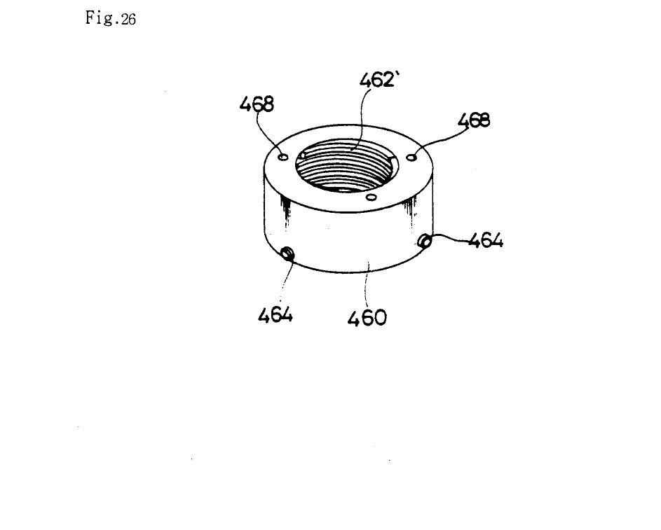

Fig. 26 illustrates an embodiment modified from the sixth embodiment. In accordance with this embodiment, guide protrusions 462 are formed in the form of a triple spiral at the inner peripheral surface of the vertical reciprocating member 460 in such a fashion that they correspond to the spiral guide grooves 444 of the rotating member 440, in place of the bearings. When the rotating member 440 rotates, the guide protrusions 462 slide along the guide grooves 444 of the rotating member 440, thereby causing the vertical reciprocating member 460 to move vertically.

Now, the procedure for vertically moving the massaging member in accordance with this embodiment will be described. When the drive gear 452 rotates in one direction in accordance with a driving operation of the normal/reverse rotating motor 450, the rotating member 440 engaged with the drive gear 452 via its gear portion 442 is rotated in one direction, for example, in a clockwise direction in Fig. 21. As a result, the bearings 462 or guide protrusions 462 of the vertical reciprocating member 460 received in the spiral guide grooves 444 of the rotating member 440 is upwardly moved along the spiral guide grooves 444. At this time, the vertical reciprocating member 460 is vertically raised because it is prevented from rotating with respect to the carrier 420. As a result, the vertical reciprocating member 460 reaches the state of Fig. 25.

In accordance with the upward movement of the vertical reciprocating member 460, the massaging member 430 fixedly mounted on the vertical reciprocating member 460 is raised., so that the massaging protrusions 432 on the massaging member 430 can strongly depress a desired portion of the spine.

When the normal/reverse rotating motor 450 rotates in a reverse direction, the rotating member 440 is rotated in the reverse direction. Accordingly, the bearings 462 or guide protrusions 462 received in the guide grooves 444 of the rotating member 440 are lowered along the spiral guide grooves 444. Thus, the vertical reciprocating member 460 is vertically lowered.

When the vertical reciprocating member 460 is lowered again from its top dead point, the bearings 462 are positioned at respective upper ends of the guide grooves 444 formed at the rotating member 440. Since the stopper 448 is provided with the bent portions 449 each partially bent to have the same angle as an associated one of the guide grooves 444 and positioned at the upper end of the associated guide groove 444, the bearings 462 are forcedly introduced into the guide grooves 444 as they are downwardly depressed by the bent portions 449. Thus, the vertical reciprocating member 460 is normally lowered along the spiral guide grooves 444 of the rotating member 440.

Industrial Applicability

As apparent from the above description, the spine massager is configured to allow its massaging member to conduct vertical reciprocating movements at an optional horizontal position, along with horizontal reciprocating movements. Accordingly, the spine massager of the present invention can provide thermotherapy and massaging effects for treating a spine trouble when it is used in a physical therapy room or home.

Claims

1. 2. A spine massager comprising a base body, a carrier mounted on the base body to reciprocate horizontally in longitudinal directions of the base body, and a massaging member installed on the carrier and provided at an upper surface thereof with a plurality of massaging protrusions, the massaging member being contained with a lamp, means for vertically moving the massaging member while allowing the massaging member to reciprocate horizontally along with the carrier, wherein the means comprises: a normal/reverse rotating motor;
a rotating gear rotatably mounted to the carrier and coupled to the normal/reverse rotating motor, the rotating gear serving to rotate horizontally in accordance with a drive force from the normal/reverse rotating motor; and
means for converting a rotating force of the rotating gear into a vertical movement force for vertically moving the massaging member.

2. 3. The spine massager according to claim 2, wherein the converting means comprises:
a cylindrical protrusion member extending downwardly from a lower surface of the massaging member, the protrusion member being fitted in the rotating gear while allowing a rotation of the rotating gear;
a plurality of spiral guide grooves formed at an outer peripheral surface of the protrusion member;
a fitting hole centrally formed at the rotating gear to receive the protrusion member;
guide members formed at an inner peripheral surface of the fitting hole to be engaged with the guide grooves, respectively;
a square hole longitudinally formed at a central portion of the protrusion member; and
a square protrusion formed at the carrier and fitted in the square hole.

3. 4. The spine massager according to claim 2, wherein the converting means comprises:
a cylindrical protrusion member extending downwardly from a lower surface of the massaging member, the protrusion member being fitted in the rotating gear while allowing a rotation of the rotating gear;
guide members formed at an outer peripheral surface of the protrusion member;
a fitting hole centrally formed at the rotating gear to receive the protrusion member;
spiral guide grooves formed at an inner peripheral surface of the fitting hole to be engaged with the guide members, respectively;
a square hole longitudinally formed at a central portion of the protrusion member; and
a square protrusion formed at the carrier and fitted in the square hole.

4. 5. (ONCE AMENDED) The spine massager according to claim 3, wherein the number of the guide grooves is three, the guide grooves being uniformly spaced apart from one another by 120°.

5. 7. A spine massager comprising a base body, a carrier mounted on the base body to reciprocate horizontally in longitudinal directions of the base body, and a massaging member installed on the carrier and provided at an upper surface thereof with a plurality of massaging protrusions, the massaging member being contained with a lamp,means for vertically moving the massaging member while allowing the massaging member to reciprocate horizontally along with the carrier, wherein the means comprises:
a horizontal guide groove formed at a lower surface of the massaging member;
a pair of rods pivotally coupled to each other at intermediate portions thereof to form an X-shaped structure;
rollers rotatably mounted to respective upper ends of the rods and slidably received in the horizontal guide groove, one of the rods being hingably mounted to the carrier at a lower end thereof;
a nut member attached to a lower end of the other one of the rods; and
a normal/reverse rotating motor fixedly mounted to the carrier and provided with a screw shaft threadedly coupled with the nut member.

6. 8. (Amended) A spine massager comprising a base body, a carrier mounted on the base body to reciprocate horizontally in longitudinal directions of the base body, and a massaging member installed on the carrier and provided at an upper surface thereof with a plurality of massaging protrusions, the massaging member being contained with a lamp,means for vertically moving the massaging member while allowing the massaging member to reciprocate horizontally along with the carrier, wherein the means comprises:
a normal/reverse motor installed on the carrier;
spiral gears each mounted to the carrier via a fixed shaft to rotate normally or reversely in accordance with a rotation of the normal/reverse rotating motor and formed with a spiral groove having a radius increasing gradually from a center of the spiral gear to an outer periphery of the spiral gear;
a vertical reciprocating member seated on the carrier while carrying the massaging member thereon; and
movable shafts each fixed to the vertical reciprocating member and received at a free end thereof in the spiral groove of an associated one of the spiral gears.

7. 9. The spine massager according to claim 8, wherein:
the spiral gears are arranged at opposite lateral ends of the carrier, respectively, so that the vertical reciprocating member is arranged therebetween;
the movable shafts are protruded from opposite lateral ends of the vertical reciprocating member so that they are received in the spiral grooves of the spiral gears, respectively; and
a bearing is fitted around each of the movable shafts to allow a smooth sliding movement of the movable shaft along an associated one of the spiral grooves.

8. 10. (ONCE AMENDED) The spine massager according to claim 8, wherein the converting means further comprises:
a plurality of guide holes formed at respective corners of the vertical reciprocating member so that they extend vertically from a bottom of the vertical reciprocating member; and
vertical guide bars fixedly mounted to an upper surface of the carrier at positions corresponding to those of the guide holes so that they are received in the guide holes, respectively.

9. 11. A spine massager comprising a base body, a carrier mounted on the base body to reciprocate horizontally in longitudinal directions of the base body, and a massaging member installed on the carrier and provided at an upper surface thereof with a plurality of massaging protrusions, the massaging member being contained with a lamp, means for vertically moving the massaging member while allowing the massaging member to reciprocate horizontally along with the carrier, wherein the means comprises:
a normal/reverse rotating motor;
a drive gear fitted around a shaft of the normal/reverse rotating motor;
a donut-shaped rotating gear mounted to a lower portion of the carrier and provided with inner and outer gear portions, the outer gear portion being engaged with the driving gear;
a plurality of rotating members each rotatably mounted to the carrier and provided at a lower end thereof with a gear portion engaged with the inner gear portion of the rotating gear, each of the rotating member being formed with a spiral guide groove at an outer peripheral surface thereof;
a vertical reciprocating member inwardly defined with receiving spaces to receive the rotating members, respectively, the vertical reciprocating member carrying the massaging member thereon; and
bearings mounted to respective outer surface portions of the vertical reciprocating member corresponding to the receiving spaces, the bearings being partially received in the guide grooves of the rotating members, respectively;
whereby the vertical reciprocating member moves vertically with respect to the carrier when the rotating members rotate in accordance with a rotating force of the rotating gear.

10. 12. A spine massager comprising a base body, a carrier mounted on the base body to reciprocate horizontally in longitudinal directions of the base body, and a massaging member installed on the carrier and provided at an upper surface thereof with a plurality of massaging protrusions, the massaging member being contained with a lamp, means for vertically moving the massaging member while allowing the massaging member to reciprocate horizontally along with the carrier, wherein the means comprises:
a rotating member rotatably mounted on the carrier and provided with a gear portion at a lower end thereof, the rotating member being also provided, at an outer peripheral surface above the gear portion, with three spiral guide grooves uniformly spaced apart from one another by 120 while extending upwardly to an upper end of the rotating member;
a normal/reverse rotating motor having a drive gear engaged with the gear portion of the rotating member; and
a vertical reciprocating member mounted in the carrier so that it is vertically movable while being prevented from rotating. the vertical reciprocating member carrying the massaging member thereon.

11. 13. The spine massager according to claim 12, wherein bearings are mounted to an inner surface of the vertical reciprocating member at a lower portion of the vertical reciprocating member while being partially received in the guide grooves of the rotating member, respectively.

12. 14. The spine massager according to claim 12, wherein guide protrusions are formed at an inner peripheral surface of the vertical reciprocating member while being engaged with the spiral guide grooves of the rotating member.

13. 15. The spine massager according to claim 12, further comprising:
a plate-shaped stopper attached to an upper end of the rotating member and adapted to prevent the vertical reciprocating member from being separated from the rotating member when it reaches a top dead point thereof, the stopper being provided with portions each partially bent to have the same angle as an associated one of the guide grooves.
